(19) United States
(12) Patent Application Publication
(10) Pub. No.: US 2009/0291255 A1
(43) Pub. Date: Nov. 26, 2009

(54) HONEYCOMB STRUCTURE

(75) Inventors: Masafumi KUNIEDA, Ibi-Gun (JP); Shinnosuke Goto, Ibi-Gun (JP); Ken Yoshimura, Ibi-Gun (JP)

Correspondence Address: DITTHAVONG MORI & STEINER, P.C., 918 Prince St., Alexandria, VA, 22314, US

(73) Assignee: IBIDEN CO., LTD., Ogaki-Shi (JP)

(21) Appl. No.: 12/368,514

(22) Filed: Feb. 10, 2009

(30) Foreign Application Priority Data
May 20, 2008 (JP) PCT/JP2008/059259

(51) Int. Cl. B32B 3/12

(52) U.S. Cl. 428/116

(57) ABSTRACT

A honeycomb structure includes at least one honeycomb unit. The at least one honeycomb unit has cell walls extending from one end face to another end face of the at least one honeycomb unit along a longitudinal direction of the at least one honeycomb unit to define cells. The at least one honeycomb unit includes zeolite, inorganic particles, and inorganic binder. The zeolite includes a hydroxyl group. The inorganic particles includes a hydroxyl group. A hydroxyl group content in the inorganic particles is greater than a hydroxyl group content in the zeolite.

### CROSS-REFERENCE TO RELATED APPLICATIONS

The present application claims priority under 35 U.S.C §119 to PCT/JP2008/059259 filed May 20, 2008, the entire contents of which are hereby incorporated herein by reference.

### BACKGROUND OF THE INVENTION

1. Field of the Invention

The present invention relates to a honeycomb structure.

2. Description of the Related Art

Conventionally, there have been developed many techniques to convert exhaust gas from vehicles. For practical use, unfortunately, it may be difficult to argue that sufficient measure have been taken against exhaust gas from vehicles. There is a trend not only in Japan but also in the entire world that regulation of exhaust gas from vehicles is becoming more and more strict. In particular, regulation for NOx emission as exhaust gas from diesel engines has been extremely aggressive. Conventionally, NOx emission has been reduced by using a method of controlling the combustion system of engines, but it has become difficult to satisfy the current NOx regulations by such a method alone. To overcome the problem, an NOx conversion system (called an SCR system) using ammonia as a reducing agent has been proposed as a diesel NOx conversion system. As a catalyst carrier being used in such systems, a honeycomb structure as disclosed in International Publication No. WO2005/063653 has been widely known.

The entire contents of International Publication No. WO2005/063653 are hereby incorporated herein by reference.

### SUMMARY OF THE INVENTION

According to an aspect of the present invention, a honeycomb structure includes at least one honeycomb unit. The at least one honeycomb unit has cell walls extending from one end face to another end face of the at least one honeycomb unit along a longitudinal direction of the at least one honeycomb unit to define cells. The at least one honeycomb unit includes zeolite, inorganic particles, and inorganic binder. The zeolite includes a hydroxyl group. The inorganic particles includes a hydroxyl group. A hydroxyl group content in the inorganic particles is greater than a hydroxyl group content in the zeolite.

### BRIEF DESCRIPTION OF THE DRAWINGS

Other objects, features, and advantages of the present invention will become more apparent from the following description when read in conjunction with the accompanying drawings, in which:

FIG. 1A is a perspective view showing a honeycomb structure according to an embodiment of the present invention, the honeycomb structure including plural honeycomb units;

FIG. 1B is a perspective view showing a honeycomb structure according to an embodiment of the present invention, the honeycomb structure including a single honeycomb unit; and

FIG. 2 is a perspective view showing a honeycomb unit to be used to constitute the honeycomb structure in FIG. 1A.

### BEST MODE FOR CARRYING OUT THE INVENTION

Embodiment will now be described with reference to the accompanying drawings, wherein like reference numerals designate corresponding or identical elements throughout the various drawings.

Further according to an embodiment of the present invention, a honeycomb structure includes a honeycomb unit having a shape in which plural cells extend along the longitudinal direction from one end face of the honeycomb unit to the another end face, the cells being separated from each other by cell walls. The honeycomb unit includes zeolite, inorganic particles, and inorganic binder. The honeycomb unit is characterized by that a hydroxyl group content in the inorganic particles is greater than a hydroxyl group content in the zeolite.

In the present description, unless otherwise described, the term “inorganic particles” refers to “inorganic particles other than zeolite”.

According to an embodiment of the present invention, the honeycomb unit of the honeycomb structure includes zeolite serving as NOx conversion catalyst, therefore, the honeycomb structure may be used as an NOx conversion catalyst for exhaust gas. Further, the honeycomb unit of the honeycomb structure according to an embodiment of the present invention includes inorganic particles other than zeolite, and a hydroxyl group content in raw-material inorganic particles before being fired is greater than a hydroxyl group content in raw-material zeolite. Because of this feature, when the zeolite, the inorganic particles, and inorganic binder are mixed as raw material to form a honeycomb unit and the honeycomb unit is fired, the hydroxyl groups in the inorganic particles form a robust bonded body by performing a dehydration condensation reaction, and as a result, a honeycomb unit having high strength may be easily formed. Herein, the hydroxyl group content in the inorganic particles and the hydroxyl group content in the zeolite refer to the hydroxyl group content in the raw-material inorganic particles and the hydroxyl group content in the raw-material zeolite before being fired to form the honeycomb unit.

In a honeycomb structure as disclosed in International Publication No. WO2005/063653, when a honeycomb unit is formed by molding and firing using zeolite as a major raw material, the strength of the honeycomb unit is likely to be largely reduced. Because of this drawback, there arises a problem that a honeycomb structure formed of the honeycomb unit can hardly serve as a honeycomb structure to be used as an NOx conversion catalyst for exhaust gas from diesel engines.

In the honeycomb structure disclosed in Patent Document 1, as a result of research for the reason why the strength of a honeycomb unit is reduced when zeolite is used as a major raw material of the honeycomb structure disclosed in International Publication No. WO2005/063653, the present inventors have made an assumption that bonding of zeolite particles due to hydration upon being fired (sintered) may not be sufficiently proceeded. Namely, it has been generally thought that the structural strength of a honeycomb unit may be increased as a result of a bonding between zeolite particles used as a major raw material and a dehydration bonding between zeolite particles and inorganic binder or inorganic fibers when a molded body of the honeycomb unit is fired (sintered). However, unfortunately, it is thought that the zeolite particles do not include sufficient hydroxyl group content, and therefore, a sufficient amount of dehydration bonding may not be induced. To overcome this situation, as a supplemental raw material, inorganic particles having more hydroxyl group content than the zeolite particles have are added when the honeycomb unit is formed, and influence of the hydroxyl group content is studied. As a result, the present inventors have found that the inorganic particles having a large amount of hydroxyl groups may contribute to the improvement of the structural strength of the honeycomb unit and completed the present invention.

According to an embodiment of the present invention, a honeycomb structure may have sufficient strength upon the honeycomb structure being mounted in a vehicle and is capable of effectively converting NOx in exhaust gas.

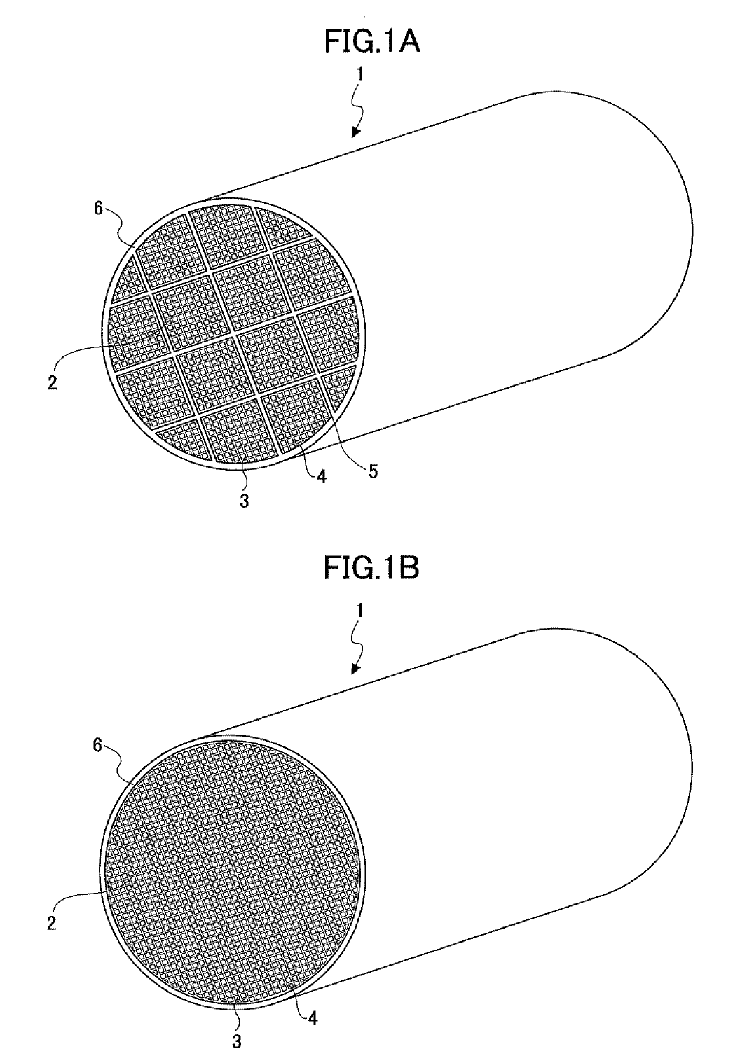

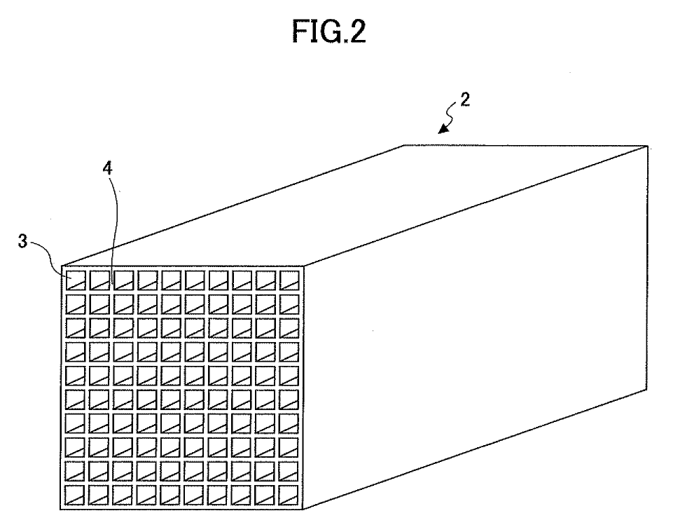

A honeycomb structure according to an embodiment of the present invention includes a honeycomb unit which is a fired body (sintered body) in which plural cells extend from one end face to the another end face along the longitudinal direction of the honeycomb structure and these cells are separated from each other by interposing cell walls. FIG. 1A perspectively shows an example of the honeycomb structure according to an embodiment of the present invention. As shown in FIG. 1A, the honeycomb structure 1 is formed by joining plural honeycomb units 2 to each other by an adhesive material 5 so that cells 3 formed in the honeycomb units 2 are arranged substantially in parallel with each other. FIG. 1B perspectively shows another example of the honeycomb structure according to another embodiment of the present invention. As shown in FIG. 1B, the honeycomb structure 1 includes a single honeycomb unit 2. As shown in FIGS. 1A and 1B, the honeycomb structure 1 may include only a single honeycomb unit 2 or plural honeycomb units 2. Preferably, a side surface of the honeycomb structure 1 in FIGS. 1A and 1B is coated with a coating material layer 6 to maintain the strength of the honeycomb structure 1. The honeycomb units 2 constituting the honeycomb structure 1 as shown in FIG. 1A include plural cells 3 (through holes) extending in the longitudinal direction of the honeycomb units 2 as perspectively shown in FIG. 2 and the cell walls 4 separating the adjoining cells 3 constitute the honeycomb unit 2.

The honeycomb unit 2 includes zeolite, inorganic particles (inorganic particles other than zeolite), and inorganic binder, the inorganic particles having more hydroxyl group content than the zeolite particles have. Herein, strictly speaking, zeolite, inorganic particles, and inorganic binder refer to particles, paste, or the like in their raw material phase. However, after being fired to form a honeycomb unit, those zeolite, inorganic particles, and inorganic binder can still be distinguished from each other as the materials deriving from their original raw materials. Therefore, the terms zeolite, inorganic particles, and inorganic binder are used herein without being changed. Therefore, the hydroxyl group content of the inorganic particles and zeolite corresponds to that of inorganic particles and zeolite particles used as raw materials for forming the honeycomb unit. Further, herein, the hydroxyl group content refers to the number of hydroxyl groups per unit volume. In the following descriptions, zeolite, inorganic particles, and inorganic binder may represent the corresponding raw materials.

In the following, each composition included in the honeycomb unit and the raw materials of the compositions are described.

### (Zeolite)

Zeolite is finely particulated and distributed in the honeycomb unit. Zeolite serves as an NOx conversion catalyst, therefore zeolite is an essential component as the NOx conversion catalyst for exhaust gas in the honeycomb structure according to an embodiment of the present invention. Zeolite is derived from a raw material of zeolite particles before being fired, and any kind of zeolite may be used as long as the zeolite has desired NOx conversion efficiency. Raw-material zeolite includes, for example, β-type zeolite, ZSM-5type zeolite, mordenite, faujasite, zeolite A, and zeolite L. Further, ion-exchanged zeolite may also be used. For example, zeolite may be preferably used in which at least one metal species of Cu, Fe, Ni, Zn, Mn, Co, Ag, and V is ion-exchanged. Any kind of zeolite alone or in combination thereof may be used.

Preferably, zeolite includes secondary particles and an average particle diameter of the secondary particles of zeolite is in a range from about 0.5 μm to about 10 μm. If the average particle diameter of the secondary particles of the zeolite is equal to or greater than about 0.5 μm, it is necessary to add a large amount of inorganic particles, which may facilitate the forming of the honeycomb unit. On the other hand, if the average particle diameter of the secondary particles of the zeolite is equal to or less than about 10 μm, a supported catalyst amount per unit volume of the honeycomb unit is unlikely to be reduced, and the NOx conversion performance for exhaust gas is also unlikely to be reduced. The average particle diameter of the secondary particles of the zeolite may be measured by using zeolite particles being particulated raw material constituting the secondary particles before being fired as the honeycomb unit.

Zeolite content included in the honeycomb unit is preferably in a range from about 40 mass % to about 80 mass % and more preferably in a range from about 50 mass % to about 70 mass %. As described above, zeolite contributes to NOx conversion, and so from this point of view, the higher zeolite content in the honeycomb unit, the better. However, when the zeolite content alone is increased, content of other element materials such as inorganic particles content and inorganic binder content are required to be reduced by that much, and as a result, the strength of the honeycomb unit is likely to be reduced and it may become difficult to form a raw honeycomb molded body having a desired shape in a molding step of the honeycomb unit.

### (Inorganic Particles)

In the honeycomb structure according to an embodiment of the present invention, inorganic particles contribute to the improvement of the strength of the honeycomb unit. Herein, inorganic particles refer to the inorganic particles other than zeolite. When no inorganic particles are used except zeolite particles, in other words, when only zeolite particles and inorganic binder are used upon the honeycomb unit being formed, the strength of the formed honeycomb unit may become very weak.

In the honeycomb structure according to an embodiment of the present invention, the inorganic particles included in the honeycomb unit may be, but not limited to, any compound of alumina, silica, zirconia, titania, ceria, mullite, and a precursor of any of these compounds. As the inorganic particles, any one of the compounds and the precursors or combination thereof may be used. As the inorganic particles, alumina or zirconia may be more preferably used. As the aluminum, α-alumina and boehmite may be preferably used.

The inorganic particles used for the honeycomb unit of the honeycomb structure according to an embodiment of the present invention include hydroxyl groups in a step when the inorganic particles are still raw-material inorganic particles before being fired. Like a majority of inorganic compound particles that can be used for industrial purposes, it is thought that the raw-material inorganic particles and the raw-material zeolite particles before being fired used for forming the honeycomb unit of the honeycomb structure according to an embodiment of the present invention include hydroxyl groups. Further, it is thought that the hydroxyl group has a tendency to reinforce the bonding between particles by performing a dehydration condensation reaction in a step when the honeycomb unit is formed. In particular, it is thought that such raw-material inorganic particles such as alumina particles are likely to firmly bond with each other by the dehydration condensation reaction in a step of being fired.

In the honeycomb unit of the honeycomb structure according to an embodiment of the present invention, a hydroxyl group content in the raw-material inorganic particles is higher than that in the raw-material zeolite particles. A ratio of the hydroxyl group content in the raw-material inorganic particles to the hydroxyl group content in the raw-material inorganic particles is preferably equal to or greater than about 2.5, more preferably equal to or greater than about 5. In this embodiment of the present invention, the bonding between the inorganic particles contributes to the improvement of the strength of the honeycomb unit. Therefore, by making the hydroxyl group content in the raw-material inorganic particles higher than that in the raw-material zeolite particles, it may become easier for the hydroxyl groups to be bonded with each other by performing the dehydration condensation reaction in a step of being fired. By doing this, it may become easier to obtain the honeycomb unit having higher strength. When the honeycomb unit becomes to have higher strength, the honeycomb structure having one or plural honeycomb units also becomes to have higher strength. Preferably, the ratio of the hydroxyl group content in the raw-material inorganic particles to the hydroxyl group content in the raw-material zeolite particles is large as much as possible. However, from a view point of easiness in forming the honeycomb unit, preferably, the ratio may be about 100 times or less.

The hydroxyl group content may be represented by the number of hydroxyl groups per 1 cm³ of the raw-material inorganic fibers or the raw-material zeolite particles. The hydroxyl group content may be measured based on the water quantification method for measuring oxide fine particles using thermal desorption spectroscopy (TDS) More specifically, sample particles are heated up to 1000° C. under high-vacuum of approximately 10⁻⁸ Pa to dehydrate the sample particles, and the water dehydrated from the sample particles at a temperature range from 550° C. to 900° C. is measured by using a quadrupole mass spectrometer.

In the honeycomb unit of the honeycomb structure according to an embodiment of the present invention, preferably, the average particle diameter of the secondary particles of the inorganic particles other than zeolite particles used as raw material is equal to or less than the average particle diameter of the secondary particles of zeolite. Particularly, the ratio of the average particle diameter of the inorganic particles other than zeolite particles to the average particle diameter of zeolite is in a range from about 1/10 to about 1/1. By doing this, the strength of the honeycomb unit may be easily enhanced due to the bonding power of the inorganic particles having smaller average particle diameters. Further, by using such inorganic particles, pored (air holes) formed due to the bonding between the secondary particles may become smaller. As a result, it may become easier to increase an amount of zeolite per unit volume, thereby becoming easier to improve the NOx conversion performance.

The inorganic particles (inorganic particles other than zeolite) content included in the honeycomb unit is preferably in a range from about 3 mass % to about 30 mass %, more preferably in a range about 5 mass % to about 20 mass %. If the inorganic particles (inorganic particles other than zeolite) content is equal to or greater than about 3 mass %, the strength is unlikely to be reduced. On the other hand, if the inorganic particles (inorganic particles other than zeolite) content is equal to or less than about 30 mass %, the zeolite content becomes relatively unlikely to be reduced, and the NOx conversion performance becomes unlikely to be reduced.

### (Inorganic Binder)

The inorganic binder may be, but not limited to, inorganic sol, a clay binder, and the like. The inorganic sol includes alumina sol, silica sol, titania sol, sepiolite sol, attapulgite sol, and water glass. The clay binders include white clay, kaolin, montmorillonite, and double chain structural type clay such as sepiolite or attapulgite. Any of inorganic sol and a clay binder alone or combination thereof after being mixed may be used. An amount of inorganic binder included in the honeycomb unit, as the solid content included in the honeycomb unit, is preferably equal to or less than about 30 mass %, more preferably in a range from about 5 mass % to about 30 mass %, and further more preferably in a range from about 10 mass % to about 20 mass %. If the inorganic binder content is in the above range, it is unlikely to become difficult to form the honeycomb unit having a desired shape.

### (Inorganic Fibers)

Inorganic fibers may be included in the honeycomb unit of the honeycomb structure according to an embodiment of the present invention. The inorganic fibers included in the honeycomb unit may be, but not limited to, one or more inorganic fibers selected from a group including alumina fibers, silica fibers, silicon carbide fibers, silica-alumina fibers, glass fibers, potassium titanate fibers, and aluminum borate fibers. Those inorganic fibers may be mixed with zeolite and inorganic binder when they are raw materials before the honeycomb unit is molded and fired. By doing this, the inorganic fibers as well as the inorganic particles and zeolite may form a fiber-reinforced fired body, which may become easier to improve the strength of the honeycomb unit.

The inorganic fibers herein are inorganic material having a larger aspect ratio (ratio of fiber length to fiber diameter) and play an effective role to improve bending strength of the honeycomb unit. The aspect ratio of the inorganic fibers is preferably in a range from about 2 to about 1000, more preferably in a range from about 5 to about 800, and further more preferably in a range from about 10 to about 500. If the aspect ratio of the inorganic fibers is equal to or greater than about 2, the contribution to the improvement of the strength of the honeycomb unit is unlikely to become small. On the other hand, if the aspect ratio is equal to or less than about 1000, clogging is more unlikely to occur in a die for molding of the honeycomb unit during a molding step and it is unlikely to become difficult to form the honeycomb unit having a desired shape. Further, the inorganic fibers may become unlikely to be folded during a molding step such as an extrusion molding of the honeycomb unit. As a result, the length of the fibers is unlikely to vary, which may become difficult to reduce the strength of the honeycomb unit. When there is a distribution range of the aspect ratio, the average aspect ratio may be used.

The inorganic fibers content included in the honeycomb unit is preferably in a range from about 3 mass % to about 50 mass %, more preferably about 3 mass % to about 30 mass %, and further more preferably in a range from about 5 mass % to about 20 mass %. If the inorganic fibers content is equal to or greater than about 3 mass %, the strength of the honeycomb unit may be unlikely to be reduced. On the other hand, if the inorganic fibers content is equal to or less than about 50 mass %, an amount of zeolite that contributes to the NOx conversion is relatively unlikely to be reduced, and the NOx conversion performance may be unlikely to be reduced.

### (Catalyst Component)

The cell walls of the honeycomb unit of the honeycomb structure according to an embodiment of the present invention may support more catalyst component. The catalyst component may be, but not limited to, a noble metal, an alkali-metal compound, alkali-earth metal compound, and the like. The noble metal catalyst may be, for example, one or more noble metals selected from a group including platinum, palladium, rhodium, and the like. The alkali-metal compound may be, for example, one or more compounds selected from a group including potassium, sodium, and the like. The alkali-earth metal may be, for example, a compound of barium and the like.

The obtained honeycomb structure may be used as, but not limited to, so-called SCR catalyst (NOx conversion catalyst), three-way catalyst, and NOx adsorber catalyst for converting exhaust gas of diesel vehicles. A step of supporting the catalyst component may be performed, but not limited to, after the honeycomb unit or honeycomb structure are formed or when raw-materials are still ceramic particles. A method of supporting the catalyst component may be, but not limited to, an impregnation method or the like.

### (Honeycomb Structure)

In the honeycomb structure according to an embodiment of the present invention, a shape of a surface arranged orthogonal to the longitudinal direction of the cells of the honeycomb unit (hereinafter simplified as a cross-section surface) may be a square, a rectangle, a hexagon, fan-shaped, and the like.

FIGS. 1A and 1B show examples of the honeycomb structure according to embodiments of the present invention. In FIGS. 1A and 1B, the honeycomb unit 2 includes plural cells (through holes) 3 extending from the lower left-hand side to the upper right-hand side. The thickness of the cell walls 4 separating the cells 3 is preferably, but not limited to, in a range from about 0.10 mm to about 0.40 mm, more preferably in a range from about 0.15 mm to about 0.35 mm, and further more preferably in a range from about 0.20 mm to about 0.30 mm. If the thickness of the cell walls 4 is equal to or greater than about 0.10 mm, the strength of the honeycomb unit is unlikely to be reduced. On the other hand, if the thickness of the cell walls 4 is equal to or less than about 0.40 mm, it may become easier for exhaust gas to sufficiently penetrate into the cell walls 4, thereby making it easier to effectively use the honeycomb unit for the purpose of NOx conversion, and as a result, the conversion performance may hardly be reduced. Further, the number of cells per unit cross-section area of the honeycomb unit is preferably in a range from about 15.5 to about 93 cells/cm² (about 100 to about 600 cpsi), more preferably in a range from about 31 to about 77.5 cells/cm² (about 200 to about 500 cpsi), and further more preferably in a range from about 46.5 to about 62 cells/cm² (about 300 to about 400 cpsi). If the number of cells is equal to or greater than 15.5 cells/cm², an area of walls in contact with exhaust gas in the honeycomb unit may become large. On the other hand, if the number of cells is equal to or less than about 93 cells/cm², a pressure loss may hardly become too high and it becomes unlikely to be difficult to form the honeycomb unit as it is desired.

The shape of the cross-section area of the cells 3 formed in the honeycomb unit is not limited. FIG. 2 shows a case where the shape of the cross-section area of the cells 3 is square. However, for example, the shape of the cross-section area of the cells 3 may be substantially a triangle or hexagon. By doing this, it may become possible to improve the strength of the porous honeycomb unit without reducing the pressure loss and the conversion performance, thereby becoming easier to improve the strength (for example, isostatic strength) of the honeycomb structure 1 as shown in FIGS. 1A and 1B.

### (Manufacturing of the Honeycomb Unit)

An exemplary manufacturing method of the honeycomb unit of the honeycomb structure according to the above mentioned embodiment of the present invention is described. First, a raw-material paste including the above-mentioned zeolite, inorganic particles, and inorganic binder as major components is prepared, and a honeycomb unit molded body is formed from the raw-material paste by, for example, extrusion molding. In addition, the above-mentioned inorganic fibers, organic binder, dispersion medium, molding aid, and the like may be adaptively added to the raw-material paste. The organic binder may be, but not limited to, one or more organic binder selected from a group including methylcellulose, carboxymethylcellulose, hydroxyethylcellulose, polyethyleneglycol phenol resin, epoxy resin, and the like. A blending amount of the inorganic binder is preferably in a range from about 1 to about 10 parts by mass with respect to 100 parts by mass in total of the solid content of the entire raw-material paste. The dispersion medium may be, but not limited to, water, organic solvent such as toluene, alcohol such as methanol, and the like. The molding aid may be, but not limited to, ethylene glycol, dextrin, fatty acid soap, polyalcohol, and the like.

Preferably, the raw-material paste may be, but not limited to, mixed and kneaded. For example, the raw-material paste may be mixed by using an apparatus such as a mixer and an attritor. Further, the raw-material paste may be well kneaded by using an apparatus such as a kneader. Preferably, a method of preparing the raw-material paste may be, but not limited to, a method of forming a shape having through holes by extrusion molding, or the like.

Next, the obtained honeycomb unit molded body is dried. The drying apparatus for drying may be, but not limited to, a microwave drying apparatus, a hot air drying apparatus, a dielectric drying apparatus, a reduced pressure drying apparatus, a vacuum drying apparatus, a freeze drying apparatus, and the like. Preferably, the obtained molded body is degreased. The degreasing conditions are not limited to, but are to be adaptively selected depending on a kind and an amount of an organic substance included in the molded body. Preferably, the molded body is degreased at a temperature of about 400° C. for about two hours. Further, the dried and degreased honeycomb unit molded body is fired. The firing conditions is not limited to, but preferably at about two hours in a range from about 600° C. to about 1200° C. for about two hours, and more preferably at about two hours in a range from about 600° C. to about 1000° C. for about two hours. If the firing temperature is equal to or greater than about 600° C., firing is more likely to proceed and the strength of the honeycomb unit is more likely to be increased. On the other hand, if the firing temperature is equal to or less than about 1200° C., zeolite crystal is unlikely to collapse and a porous honeycomb unit may be easily manufactured because much firing is likely to be avoided.

### (Manufacturing of Honeycomb Structure)

Next, a method of manufacturing the honeycomb structure including plural honeycomb units is described. An adhesive material is applied to side surfaces of the thus-obtained honeycomb units, so that the honeycomb units are bonded to each other one by one to form a honeycomb unit bonded body. Then the obtained honeycomb unit bonded body is dried and solidified so that the honeycomb unit bonded body has a desired size. Then the side surfaces of the honeycomb unit bonded body are cut to have a desired shape.

The adhesive material may be, but not limited to, a mixture of inorganic binder and ceramic particles, a mixture of inorganic binder and inorganic fibers, a mixture of inorganic binder, ceramic fibers, inorganic particles, and the like. Further, organic binder may be added to the adhesive material. The organic binder may be, but not limited to, one or more organic binder selected from a group including polyvinyl alcohol (PVA), methylcellulose (MC), ethylcellulose (EC), carboxymethylcellulose (CMC), and the like.

Preferably, the thickness of the layer of the adhesive material (adhesive material layer) for bonding the plural honeycomb units is in a range from about 0.5 mm to about 2 mm. The number of honeycomb units to be bonded to each other may be adaptively determined according to a size of honeycomb structure used as the honeycomb catalyst. Further, the honeycomb unit bonded body formed by bonding honeycomb units with the adhesive material may be adaptively cut and polished according to the shape of the honeycomb structure to be formed.

Next, a coating material is applied to the outer peripheral surface on which no opening of the through holes of the honeycomb structure is formed. Then the coating material is dried and solidified to form a coating material layer. By doing this, it may become easier to protect the outer peripheral surface of the honeycomb structure and increase the strength of the honeycomb structure. The coating material is not limited to and may be the same as or different from the adhesive material. Further, the compounding ratio in the coating material may be the same as or different from that in the adhesive material. The thickness of the layer of the coating material (coating material layer) is not limited to, but is preferably in a range from about 0.1 mm to about 3 mm. The coating material layer may be or may not be formed.

After the plural honeycomb units are bonded to each other by interposing the adhesive material, it is preferable to heat the plural honeycomb units. When the coating material layer is formed, it is preferable to heat the plural honeycomb units after the adhesive material layer and the coating material layer are formed. In such a case where the adhesive material layer and the coating material layer include organic binder, the organic binder may be degreased and eliminated in this heating process. The heating conditions may be adaptively determined according to a kind and an amount of an included organic substance. Preferably, the heating may be performed at a temperature of about 700° C. for about two hours.

FIG. 1A is a schematic diagram showing an example of the honeycomb structure 1 having a cylindrical shape, the honeycomb structure including plural honeycomb units that are bonded to each other and that have a rectangular pillar shape and a square-shaped cross-section surface. In this honeycomb structure 1, the honeycomb units 2 are bonded to each other by interposing the adhesive material 5, the outer peripheral part is cut so that the honeycomb structure 1 have a cylindrical shape, and the coating material layer 6 is formed. However, the present invention is not limited to this configuration. For example, the honeycomb units 2 may be formed so as to have a fan-shaped or a square-shaped cross-section surface, and those honeycomb units are bonded to each other so that the honeycomb structure has a desired shape without performing the cutting and polishing processes.

Next, a method of manufacturing the honeycomb structure including a single honeycomb unit is described. The honeycomb unit is formed so as to have a cylindrical shape in the same manner as described above in which the honeycomb structure having plural honeycomb units is formed, and the coating material layer is formed on the outer peripheral part of the honeycomb unit. By doing this, the honeycomb structure 1 having a single honeycomb unit 2 may be manufactured.

### EXAMPLES

In the following, the honeycomb structures according to examples of the present invention manufactured under various conditions are described. However, the present invention is not limited to those examples.

### Example 1

### Manufacturing the Honeycomb Units

First, 2250 parts by mass of zeolite particles (hydroxyl group content: 10.7×10¹⁹ units/cm³, average particle diameter: 2 μm (herein, the average particle diameter refers to the average particle diameter of the secondary particles)), 250 parts by mass of γ-alumina particles (hydroxyl group content: 1.63×10²⁰ units/cm³, average particle diameter: 0.5 μm), 680 parts by mass of alumina fibers (average fiber diameter: 6 μm, average fiber length: 100 μm), 2600 parts by mass of alumina sol (solid concentration: 30 mass %), and 320 parts by mass of methylcellulose as organic binder are added to each other and mixed. Then, while a small amount of a plasticizing agent, a surface-activating agent, and a lubricant agent are added to the mixture and water is added to adjust the viscosity of the paste, the mixture is mixed and kneaded to obtain a mixed composition for forming the honeycomb unit. Then, the mixed composition is extrusion molded by using an extrusion molding apparatus to obtain a raw honeycomb molded body.

The obtained raw honeycomb molded body is fully dried by using a microwave drying apparatus and a hot air drying apparatus, then degreased at a temperature of 400° C. for two hours, and then fired at a temperature of 700° C. for two hours to obtain a honeycomb unit having a rectangular pillar shape (cross section 35 mm×35 mm×length 150 mm), a cell density of 93 units/cm², a wall thickness of 0.2 mm, and a cell shape of a quadrangle (square cross-section).

Table 1 collectively shows the data of the hydroxyl group content, average particle diameter, compounding amount of the zeolite particles and the alumina particles (inorganic particles) used when the honeycomb units are manufactured, a ratio of the hydroxyl group content of alumina particles (inorganic particles) to the hydroxyl group content of zeolite particles, and bending strength of the honeycomb unit based on the three points bending test results.

TABLE 1

| | | | | | | | | HYDROXYL | |
|---|---|---|---|---|---|---|---|---|---|
| | ZEOLITE | | | INORGANIC PARTICLES | | | | GROUP IN | |
| | COM- | HY- | | | COM- | HY- | | INORGANIC | EVALU- |
| | POUNDING | DROXYL | AVERAGE | | POUNDING | DROXYL | AVERAGE | PARTICLES/ | ATION |
| | AMOUNT | GROUP | PARTICLE | | AMOUNT | GROUP | PARTICLE | HYDROXYL | BENDING |
| | (PART BY | (UNITS/ | DIAMETER | | (PART BY | (UNITS/ | DIAMETER | GROUP IN | STRENGTH |
| | WEIGHT) | cm³) | (μm) | KIND | WEIGHT) | cm³) | (μm) | ZEOLITE | (MPa) |
| EXAMPLE 1 | 2250 | 1.07 * E+19 | 2 | ALUMINA | 250 | 1.63 * E+20 | 0.5 | 15.2 | 11.3 |
| EXAMPLE 2 | 2000 | 1.07 * E+19 | 2 | ALUMINA | 500 | 1.63 * E+20 | 0.5 | 15.2 | 11.8 |
| EXAMPLE 3 | 1700 | 1.07 * E+19 | 2 | ALUMINA | 800 | 1.63 * E+20 | 0.5 | 15.2 | 12.7 |
| EXAMPLE 4 | 2000 | 1.07 * E+19 | 2 | BOEHMITE | 500 | 3.65 * E+20 | — | 34.1 | 12.5 |
| EXAMPLE 5 | 2000 | 1.07 * E+19 | 2 | SILICA | 500 | 8.42 * E+19 | 0.5 | 7.9 | 10.9 |
| EXAMPLE 6 | 2000 | 6.12 * E+19 | 2 | ALUMINA | 500 | 1.63 * E+20 | 0.5 | 2.7 | 10.7 |
| EXAMPLE 7 | 2000 | 6.54 * E+18 | 10 | ALUMINA | 500 | 1.63 * E+20 | 0.5 | 24.9 | 11.2 |
| EXAMPLE 8 | 2000 | 1.07 * E+19 | 2 | ALUMINA | 500 | 6.54 * E+19 | 2.0 | 6.1 | 10.2 |
| COMPARATIVE | 2500 | 1.07 * E+19 | 2 | — | — | — | — | — | 6.2 |
| EXAMPLE 1 | | | | | | | | | |
| COMPARATIVE | 2000 | 6.12 * E+19 | 2 | ALUMINA | 500 | 2.85 * E+19 | 2.0 | 0.5 | 6.8 |
| EXAMPLE 2 | | | | | | | | | |

The hydroxyl group contents of zeolite particles and alumina particles are measured based on the water quantification method for measuring oxide fine particles by using a thermal desorption spectroscopy (TDS) measuring instrument TPD type (RIGAKU. K.K.). More specifically, in this analysis and testing method, a sample is placed on a SiC sample table and heated under the following conditions by radiating infrared light from the lower side while the sample is on a quartz stage in a high vacuum chamber having a pressure of the order of 10 to 8 Pa. Then, the gas desorbed from the sample under the conditions is directly measured by a quadrupole mass spectrometer. After five minutes of waiting time from when the sample is placed in the high-vacuum chamber so that the pressure in the chamber becomes stable, this measurement starts. The heating conditions are such that the temperature is increased from the room temperature up to 1000° C. at a rate of 1° C./second. The measurement conditions of the mass spectrometer are as follows: measurement method: MID, measurement mass measurement: m/z 18, measurement ionizing method: electron-impact ionization method, and ionizing voltage: 70 eV.

The three points bending test with respect to the honeycomb units are performed in compliance with JIS (Japanese Industrial Standard)-R1601. As a measurement instrument, an Instron 5582 is used. A braking load W is vertically applied to the cell wall under the conditions that span L: 135 mm, crosshead speed: 1 mm/min. The bending strength σ is calculated by the following formula 1.

σ=WL/4Z (1)

Where area moment of inertia Z is calculated in advance by cancelling the moment of the hollow parts of the cells.

The entire contents of JIS-R1601 are hereby incorporated herein by reference.

### (Manufacturing the Honeycomb Structure)

An adhesive material paste is applied to the side surfaces of the honeycomb units so that the thickness of the adhesive material layer is 1 mm, and the honeycomb bonded body having four bonded units wide and four bonded units deep (total 16 honeycomb units) is formed. The adhesive material paste is formed by mixing 26 mass % of γ-alumina particles (average particle diameter: 2 μm), 37 mass % of alumina fibers (average fiber diameter: 10 μm, average fiber length: 100 μm), 31.5 mass % of alumina sol (solid concentration: 20 mass %), 0.5 mass % of carboxymethylcellulose, and 5 mass % of water. The side walls of the obtained honeycomb bonded body having a substantially rectangular pillar shape is cut by using a diamond cutter so that the shape of the honeycomb bonded body becomes a cylindrical shape. Then, as a paste, the coating material (same as the adhesive material) is applied to the outer surface of the side wall parts of the cylindrical shape honeycomb bonded body so that the thickness of the above-mentioned adhesive material paste layer is 0.5 mm to form the honeycomb bonded body having the cylindrical shape which is substantially the same shape of the honeycomb structure 1 shown in FIG. 1A. This honeycomb bonded body having the cylindrical shape is dried at a temperature of 120° C. and then the adhesive material layer and the paste of an outer wall are degreased by heating at a temperature of 700° C. for two hours to obtain the honeycomb structure having a cylindrical shape (diameter: 138 mm, height: 150 mm).

### Examples 2-8 and Comparative Examples 1,2

### (Manufacturing of Honeycomb Units)

Honeycomb units according to examples 2 through 8 and comparative example 1 and 2 are respectively manufactured in the same manner as described in above example 1 except that the data (conditions) of the compounding amount the hydroxyl group content, and the average particle diameter, of the raw-material zeolite particles and the raw-material alumina particles (inorganic particles) are changed as shown in Table 1. In comparative example 1, the honeycomb unit is manufactured without using inorganic particles. The bending strength of the honeycomb units (having the shape shown in FIG. 2) is measured in the same manner as described in the above example 1, and the results are shown in Table 1.

### (Evaluation Results)

As the results in Table 1 shows, each three points bending strength of the honeycomb units which are the basic unit of the corresponding honeycomb structures in examples 1 through 8 exceeds 10 MPa, which means that the strength of the honeycomb structures using those honeycomb units according to the examples 1 through 8 is high. On the other hand, the three point bending strength of the honeycomb unit in comparative example 1 formed from zeolite, inorganic fibers, and inorganic binder (without inorganic particles other than zeolite) and the honeycomb unit in comparative example 2 in which the hydroxyl group content in zeolite particles is less than that in inorganic (alumina) particles is in the order of 6 MPa, which means that the strength of the honeycomb structures using those honeycomb units of the comparative examples 1 and 2 is not enough. For further comparison, in example 6, the hydroxyl group content in zeolite particles is the same as that in comparative example 2. However, as a result, the three point bending strength in the example 6 exceeds 10 MPa. This is because the hydroxyl group content in inorganic (alumina) particles is greater than that in zeolite.

In the honeycomb structure according to an embodiment of the present invention, zeolite is distributed across the entire cell walls. Therefore, the entire cell walls are more likely to contribute to the NOx conversion. Further, the strength of the honeycomb structure according to an embodiment of the present invention is high. Therefore, the honeycomb structure may be robust against vibrations and used as a catalyst layer for vehicles. Particularly, the honeycomb structure according to an embodiment of the present invention may be optimally used as an NOx conversion catalyst for an SCR system (for example diesel exhaust gas conversion system using ammonia) requiring zeolite catalyst.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teachings herein set forth.

What is claimed is:

1. A honeycomb structure comprising:
at least one honeycomb unit having cell walls extending from one end face to another end face of the at least one honeycomb unit along a longitudinal direction of the at least one honeycomb unit to define cells, the at least one honeycomb unit comprising:
zeolite including a hydroxyl group;
inorganic particles including a hydroxyl group, a hydroxyl group content in the inorganic particles being greater than a hydroxyl group content in the zeolite; and
inorganic binder.

2. The honeycomb structure according to claim 1, wherein
the hydroxyl group content in the inorganic particles per unit volume is at least about 2.5 times as much as the hydroxyl group content in the zeolite per the unit volume.

3. The honeycomb structure according to claim 1, wherein
the inorganic particles include at least one compound of alumina, silica, titania, zirconia, ceria, mullite, and a precursor of one of the compounds.

4. The honeycomb structure according to claim 1, the at least one honeycomb unit further comprising:
inorganic fibers.

5. The honeycomb structure according to claim 1, wherein
the inorganic fibers includes at least one of alumina fibers, silica fibers, silicon carbide fibers, silica-alumina fibers, glass fibers, potassium titanate fibers, and aluminum borate fibers.

6. The honeycomb structure according to claim 1, wherein
the inorganic binder includes at least one of alumina sol, silica sol, titania sol, water glass, sepiolite, and attapulgite.

7. The honeycomb structure according to claim 1, wherein
the zeolite includes secondary particles, and
an average particle diameter of the secondary particles of the zeolite is in a range from about 0.5 μm to about 10 μm.

8. The honeycomb structure according to claim 1, wherein
an average particle diameter of secondary particles of the inorganic particles is equal to or less than an average particle diameter of the zeolite.

9. The honeycomb structure according to claim 1, wherein
a content of the zeolite is in a range from about 40 mass % to about 80 mass %.

10. The honeycomb structure according to claim 1, wherein
a content of the inorganic particles is in a range from about 3 mass % to about 30 mass %.

11. The honeycomb structure according to claim 1, wherein
the zeolite is ion-exchanged by at least one of metal species selected from a group consisting of Cu, Fe, Ni, Zn, Mn, Co, Ag, and V.

12. The honeycomb structure according to claim 1, wherein
a catalyst component is provide on the cell walls.

13. The honeycomb structure according to claim 12, wherein
the catalyst component includes at least one of a noble metal, an alkali-metal compound, and an alkali-earth metal compound.

14. The honeycomb structure according to claim 1, wherein the at least one honeycomb unit comprises plural honeycomb units which are bonded to each other by interposing adhesive material between the plural honeycomb units.

15. The honeycomb structure according to claim 1, wherein
the at least one honeycomb unit is constituted of one honeycomb unit.

16. The honeycomb structure according to claim 1, wherein
a coating material layer is provided on an outer peripheral part of the at least one honeycomb unit.

17. The honeycomb structure according to claim 2, wherein
the hydroxyl group content in the inorganic particles per unit volume is at least about 5 times as much as the hydroxyl group content in the zeolite per the unit volume.

18. The honeycomb structure according to claim 2, wherein
a ratio of the hydroxyl group content in the inorganic particles to the hydroxyl group content in the zeolite is about 100 times or less.

19. The honeycomb structure according to claim 1, wherein
a ratio of an average particle diameter of the inorganic particles to an average particle diameter of secondary particles of the zeolite is in a range from about 1/10 to about 1/1.

20. The honeycomb structure according to claim 1, wherein
the inorganic binder is inorganic sol or a clay binder.

21. The honeycomb structure according to claim 1, wherein
an amount of the inorganic binder, as a the solid content included in the at least one honeycomb unit, is in a range from about 5 mass % to about 30 mass %.

22. The honeycomb structure according to claim 4, wherein
An aspect ratio of the inorganic fibers is in a range from about 2 to about 1000.

23. The honeycomb structure according to claim 4, wherein
A content of the inorganic fibers is in a range from about 3 mass % to about 50 mass %.

24. The honeycomb structure according to claim 1, wherein
the honeycomb structure is so constructed to be used as an SCR catalyst, a three-way catalyst, or an NOx adsorber catalyst.
